(19) United States
(12) Patent Application Publication
(10) Pub. No.: US 2019/0202100 A1
(43) Pub. Date: Jul. 4, 2019

(54) METHOD OF MANUFACTURING POLYMER COMPOSITES COMPRISING AGRO-WASTE PARTICLES

(71) Applicant: ROYAL COMMISSION YANBU COLLEGES & INSTITUTES, Yanbu al-Sinaiyah (SA)

(72) Inventors: Selvin P. THOMAS, Kerala (IN); Aravinthan GOPANNA, Tamil Nadu (IN); Khalid ALZAHRANI, Yanbu al-Sinaiyah (SA)

(73) Assignee: ROYAL COMMISSION YANBU COLLEGES & INSTITUTES, Yanbu al-Sinaiyah (SA)

(21) Appl. No.: 15/860,727

(22) Filed: Jan. 3, 2018

(51) Int. Cl. B29C 47/00; C08L 23/12; C08J 3/00; C08J 11/12; B29B 13/08; B29B 7/00; B29B 13/02; B29C 47/88

(52) U.S. Cl. CPC B29C 47/0004; C08L 23/12; C08J 3/005; C08J 11/12; B29B 13/08; B29K 2023/12; B29B 13/02; B29C 47/8895; C08J 2323/12; C08J 2497/02; B29B 7/005

(57) ABSTRACT

A method of manufacturing a polymer composite comprising a polymer phase and agro-waste particles dispersed in the polymer phase, wherein the polymer phase is preferably obtained from polyolefin containing waste plastics, and the agro-waste particles are preferably obtained from date palm wood flour particles. Various combinations of embodiments are provided.

### BACKGROUND OF THE INVENTION

### Technical Field

The present invention relates to a method of manufacturing a polymer composite comprising a polymer phase that contains polyolefin and agro-waste particles dispersed in the polymer phase.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Polyolefin materials are generally cheap and lightweight and can be molded into various shapes to be used in a wide range of applications, for example, ropes, insulators, kitchen supplies, packaging for food, water, milk, detergents, and large volume industrial chemicals, and for the manufacture of toys, caps, wire, cable jacketing, silos, automotive parts, and medical supplies. On a worldwide basis, polyolefin materials are consumed in the greatest quantity (approximately 14 billion pounds in the USA). Since many polyolefin materials/plastics are not biodegradable, disposal presents a major threat to the environment, particularly for municipalities and industry.

Certain polyolefin waste plastics, e.g. polypropylene, are not biodegradable and thus have a life cycle much longer than naturally occurring materials such as wood. In addition, polyolefin waste plastics can be tailor-made to improve chemical, environmental, bacterial, fungal and/or other biological-related properties. Also, mechanical, electrical, and/or flame-resistant properties of the polyolefin waste plastics can be modified as needed for particular applications.

Some countries such as Saudi Arabia are well recognized for palm trees (e.g. Phoenix dactylifera L.). Agro-waste materials from palm trees are usually discarded as materials with no use or value. However, certain waste materials, i.e. date palm stems, leafs, leaflets, roots, pits, and trunks may contain constituents such as oils (up to 10%), minerals (considerably rich in potassium), and fibers (46.4%) that may be utilized for specific purposes.

In view of the forgoing, one objective of the present disclosure is to provide a method of manufacturing a polymer composite comprising a polymer phase and agar-waste particles dispersed in the polymer phase. The polymer phase is preferably obtained from polyolefin containing waste plastics, and the agro-waste particles are preferably obtained from date palm wood flour particles.

### BRIEF SUMMARY OF THE INVENTION

According to a first aspect, the present disclosure relates to a method of manufacturing a polymer composite comprising a polymer phase and agro-waste particles dispersed in the polymer phase, the method involving i) plasma treating polymer pellets, which comprise at least 80% by weight of a polyolefin relative to the total weight of the polymer pellets, ii) mixing agro-waste particles with the polymer pellets to form a homogenous mixture, iii) heating the homogenous mixture to form an extrusion precursor, and iv) extruding the extrusion precursor thereby forming the polymer composite.

In one embodiment, the agro-waste particles are mixed with the polymer pellets at a weight ratio of 1:20 to 2:1.

In one embodiment, the method further involves treating the agro-waste particles with an alkaline solution, an acid solution, an oxidizer, and/or a silane solution before the mixing.

In one embodiment, the agro-waste particles are treated with the alkaline solution, the acid solution, the oxidizer, and the silane solution; wherein the alkaline solution is a sodium hydroxide solution, the acid solution is a chromic acid solution and/or a sulfuric acid solution, and the oxidizer is at least one selected from the group consisting of sodium hypochlorite, hydrogen peroxide, sodium percarbonate, and sodium perborate.

In one embodiment, the method further involves flame treating the agro-waste particles before the treating.

In one embodiment, the method further involves corona treating the polymer pellets before the mixing.

In one embodiment, the method further involves acid-treating the polymer pellets before the plasma treating.

In one embodiment, the method further involves i) washing the agro-waste particles and drying at a temperature of 20 to 100° C. before the mixing, ii) cooling the polymer composite in a water bath after the extruding.

In one embodiment, the homogenous mixture is heated to a temperature of 200 to 300° C. to form the extrusion precursor.

In one embodiment, the polymer pellets contain polypropylene and at least a secondary polymer selected from the group consisting of polyethylene, acrylic, polyamide, polystyrene, polyvinylchloride, acrylonitrile butadiene styrene, and polycarbonate, wherein a weight ratio of the secondary polymer to the polypropylene is 1:20 to 1:4.

In one embodiment, the agro-waste particles comprise date palm wood flour particles.

In one embodiment, an average particle diameter of the agro-waste particles in the range of 100 to 1,000 μm.

In one embodiment, the homogenous mixture does not include a compatibilizing agent.

In one embodiment, the method further involves mixing a compatibilizing agent with the agro-waste particles and the polymer pellets to form the homogenous mixture, wherein the compatibilizing agent is at least one compound selected from the group consisting of maleic anhydride grafted polyethylene, maleic anhydride grafted polystyrene, vinyl acetate, methyl methacrylate, phenol formaldehyde, and sodium silicate, and wherein the compatibilizing agent is mixed with the polymer pellets at a weight ratio of 1:200 to 1:5.

In one embodiment, the method further involves mixing a UV stabilizer with the agro-waste particles and the polymer pellets to form the homogenous mixture, wherein the UV stabilizer is at least one compound selected from the group consisting of a benzotriazole, a benzophenone, a benzoate, a nickel organic complex, and a hindered amine light stabilizer, and wherein the UV stabilizer is mixed with the polymer pellets at a weight ratio of 1:1000 to 1:100.

In one embodiment, the method further involves mixing a lubricant with the agro-waste particles and the polymer pellets to form the homogenous mixture, wherein the lubricant comprises a silicone elastomer, and wherein the lubricant is mixed with the polymer pellets at a weight ratio of 1:100 to 1:10.

In one embodiment, the polymer pellets are obtained from pelletizing polyolefin-containing waste plastics.

In one embodiment, an average diameter of the polymer pellets is 0.1 to 10 mm.

In one embodiment, the polymer pellets are polypropylene pellets, therein the compatibilizing age maleic anhydride grafted polypropylene, and wherein the compatibilizing agent is mixed with the polypropylene pellets at a weight ratio of 1:100 to 1:10.

In one embodiment, the polymer composite has at least one of the following properties, a tensile strength of 10 to 50 MPa, a tensile modulus of 1.0 to 3.0 GPa, a flexural strength of 30 to 50 MPa, a flexural modulus of 1.0 to 2.5 GPa, and an impact strength of 1.2 to 2.0 kJ/m².

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is a block flow diagram of a method of manufacturing a polymer composite comprising a polymer phase and agro-waste particles dispersed therein.

FIG. 1B is a block flow diagram of a method of manufacturing the polymer composite, wherein the method comprises additional processing steps of treating polymer pellets and agro-waste particles before mixing.

FIG. 1C is a block flow diagram of a method of manufacturing a polymer composite comprising a polypropylene phase with date palm wood flour particles dispersed therein.

FIG. 2 is an image of the date palm wood flour particles.

FIG. 3 is an image of an extruder during manufacturing the polymer composite.

FIG. 4 is an image of the polymer composite in a form of strands.

FIG. 5 is an image of (a) pelletized polypropylene, a pelletized polymer composite that contains polypropylene and (b) 5 wt %, (c) 10 wt %, (d) 20 wt %, or (e) 30 wt % of the date palm wood flour particles, relative to the total weight of the pelletized polymer composite.

FIG. 6A represents DSC thermograms in a cooling ramp of (a) polypropylene, a polymer composite that contains polypropylene and (b) 5 wt %, (c) 10 wt %, (d) 20 wt %, or (e) 30 wt % of the date palm wood flour particles, relative to the total weight of the polymer composite.

FIG. 6B represents DSC thermograms in a heating ramp of (a) polypropylene, a polymer composite that contains polypropylene and (b) 5 wt %, (c) 10 wt %, (d) 20 wt %, or (e) 30 wt % of the date palm wood flour particles, relative to the total weight of the polymer composite.

FIG. 7A represents TGA thermograms of (a) polypropylene, a polymer composite that contains polypropylene and (b) 5 wt %, (c) 10 wt %, (d) 20 wt %, or (e) 30 wt % of the date palm wood flour particles, relative to the total weight of the polymer composite.

FIG. 7B represents first derivative of the TGA thermograms of (a) polypropylene, a polymer composite that contains polypropylene and (b) 5 wt %, (c) 10 wt %, (d) 20 wt %, or (e) 30 wt % of the date palm wood flour particles, relative to the total weight of the polymer composite.

FIG. 8 represents variations of tensile strength and tensile modulus of the polymer composite with respect to the amount of the date palm wood flour particles.

FIG. 9 represents variations of flexural strength and flexural modulus of the polymer composite with respect to the amount of the date palm wood flour particles.

FIG. 10 represents variations of impact strength of the polymer composite with respect to the amount of the date palm wood flour particles.

### DETAILED DESCRIPTION OF THE EMBODIMENTS

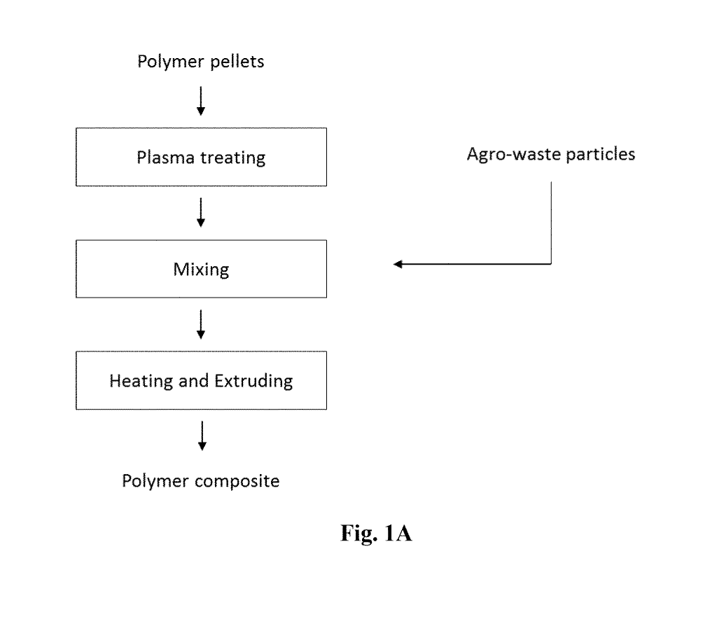

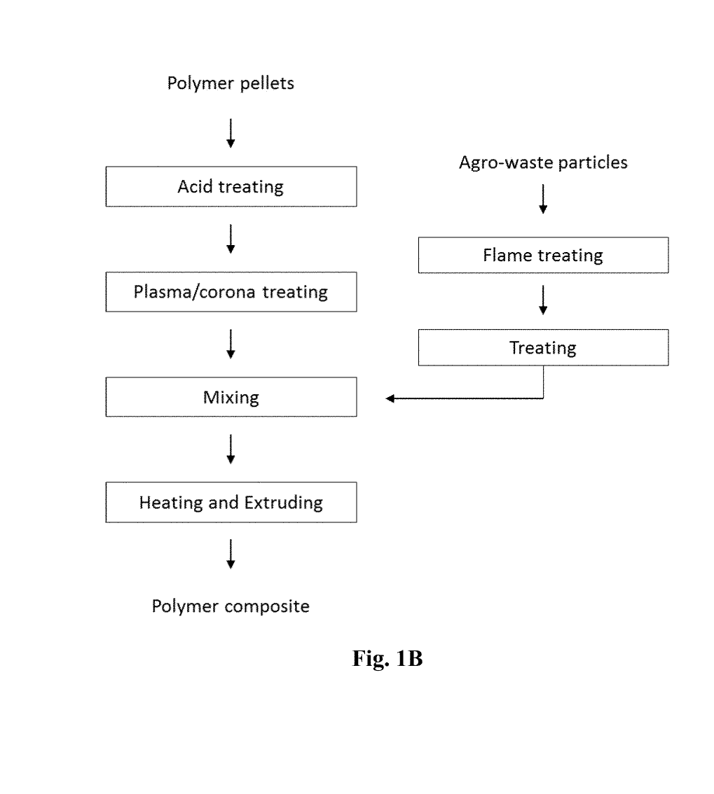

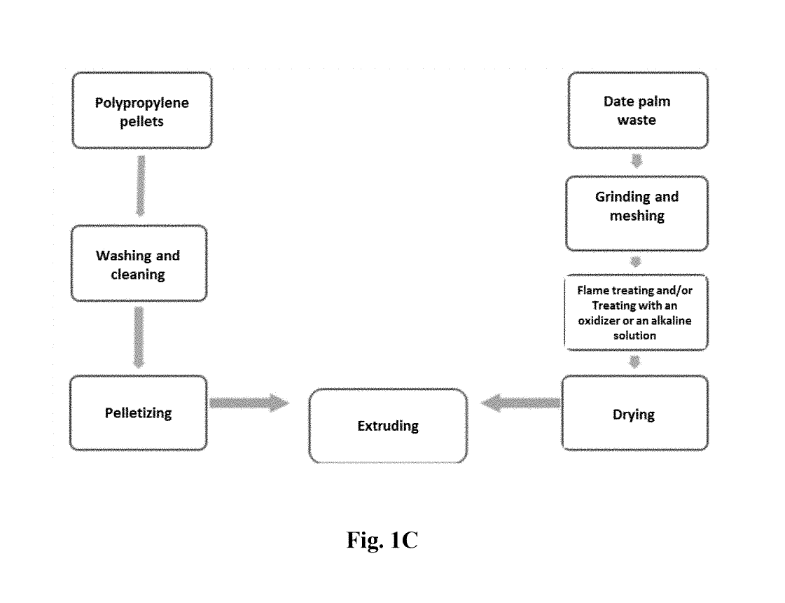

Referring to FIGS. 1A through 1C, according to a first aspect, the present disclosure relates to a method of manufacturing a polymer composite that includes a polymer phase and agro-waste particles dispersed in the polymer phase.

In preferred embodiments, the polymer phase comprises a polyolefin. The polyolefin may be, for example, polypropylene (PP), high density polyethylene (HDPE), low density polyethylene (LDPE), linear low density polyethylene (LLDPE), ultra-high molecular weight polyethylene (UHMWPE), polystyrene (PS), etc., as well as mixtures of one or more of these polyolefins. In some embodiments, the polymer phase contains at least 80 wt %, preferably at least 85 wt %, preferably at least 90 wt %, preferably at least 95 wt % of a polyolefin compound, preferably polypropylene, relative to the total weight of the polymer phase. In some preferred embodiments, the polymer phase may consist of polypropylene. In some preferred embodiments, the polymer phase contains a polyolefin (preferably polypropylene) and may further contain at least one secondary polymer, which is different from the employed polyolefin. In a preferred embodiment, the at least one secondary polymer is a thermoplastic polymer selected from the group consisting of polyethylene, acrylic, polyimide, polystyrene, poly(vinyl chloride), acrylonitrile butadiene styrene, polycarbonate, thermoplastic polyesters (e.g. PET or PBT), poly(phenylene oxide), and polyacetal. In another embodiment, the secondary polymer may be a thermosetting polymer such as, for example, an epoxy polymer, a vinyl ester, a thermosetting polyester, a melamine formaldehyde, a urea formaldehyde, etc. A weight ratio of the secondary polymer, when present, to the polypropylene may be in the range of 1:20 to 1:4, preferably 1:18 to 1:5, preferably 1:15 to 1:10.

Examples of the secondary polymer that may be used in the polymer phase may include, without limitation, poly(styrenes) such as styrene-containing copolymers, e.g. acrylonitrile-styrene copolymers, styrene-butadiene copolymers, and styrene-vinylbenzylhalide copolymers; polycarbonates; cellulosic polymers, such as cellulose acetate-butyrate, cellulose propionate, ethyl cellulose, methyl cellulose, nitrocellulose; polyamides and polyimides, such as aryl polyamides and aryl polyimides; polyethers; poly(arylene oxides), such as poly(phenylene oxide) and poly(xylene oxide); poly(esteramide-diisocyanate); polyurethanes; polyesters (including polyarylates), such as polyethylene terephthalate, polybutylene terephthalate, poly(alkyl methacrylates), poly(alkyl acrylates), poly(phenylene terephthalate); polysulfides; polymers from monomers having alpha-olefinic unsaturation other than mentioned above such as poly(ethylene), poly(butene-1), poly(4-methyl pentene-1), polyvinyls, e.g. poly(vinyl chloride), poly(vinyl fluoride); poly(vinylidene chloride), poly(vinylidene fluoride), poly(vinyl alcohol), poly(vinyl esters) such as poly(vinyl acetate), poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), polyvinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly(benzimidazole); polycarbodiimides; polyphosphazines; and grafts and blends containing any of the foregoing.

In the most preferred embodiments, the polymer phase is obtained from polyolefin-containing waste plastics, e.g. packages of food containers, water bottles, milk bottles, detergent containers, industrial chemical containers, toys, caps, cable jacketing, automotive parts, medical supplies, etc. The polyolefin-containing waste plastics may contain polypropylene (PP), high density polyethylene (HDPE); low density polyethylene (LDPE), linear low density polyethylene (LLDPE), ultra-high molecular weight polyethylene (UHMWPE), as well as mixtures of one or more of these polymers. The polyolefin-containing waste plastics may optionally contain one or more of the secondary polymers, as described previously.

Physical characteristics, e.g. tensile strength/modulus, elongation, flexural strength/modulus, and impact resistance of the polymer phase which is obtained from polyolefin-containing waste plastics may be 1% to 20% or 5% to 15% lower than the physical characteristics of polyolefin-containing materials that are not recycled. In view of that, incorporating agro-waste particles to the polymer phase, which is obtained from polyolefin-containing waste plastics, may advantageously improve the physical characteristics of the polymer composite when a waste plastic is employed.

As used herein, the “ago-waste particles” are the granulate or particulate forms of waste which is produced from various agricultural activities (e.g., farming), and may be obtained from residual plant materials such as husks, shells, stems, roots, leaves, leaflets, and/or cores of vegetable matter. Accordingly, in some preferred embodiments the agro-waste particles includes date palm wood flour particles. The “date palm wood flour particles” may preferably refer to sawdust (or wood flour) of date palm wastes, e.g. trunks, pits, roots, stems, leaves, and/or leaflets of date palm trees. In one embodiment, the agro-waste particles include only date pit particulates that are obtained for example from the fruit of Phoenix dactylifera L., e.g. khlaas or sekari. Accordingly, date pits/minks may first be ground and/or chopped, and then sieved through mesh screens with a mesh size number ranging from 20 to 80, preferably 22 to 60 to form particulates with an average size of about 0.25 mm and 1.0 mm. Similarly, date palm roots, stems, leaves, and/or leaflets may first be chopped and then sieved through screens with a mesh size number ranging from 20 to 80, preferably 22 to 60 to form particulates with an average size of about 0.25 non and 1.0 mm.

Alternatively the agro-waste particles may further include, without limitation, soybean hulls, cellulosic fibers, cellulose, grass, coconut shells, rice husks, corn stalks, and wheat straw. In one embodiment, the Agro-waste particles may further include wood chips and/or wood pulps that remain after wood processes (e.g., sawmills in lumber yards or carpentries). The agro-waste particles may preferably include at least 90% by volume, preferably at least 95% by volume, preferably at least 98% by volume of the date palm wood flour particles, relative to the total volume of the agro-waste particles. The agro-waste particles may have an average particle diameter in the range of 100 to 1,000 μm, preferably 150 to 950 μm, preferably 250 to 900 μm, preferably 400 to 850 μm.

A composition of the agro-waste particles may vary depending on the type of the agro-waste particles. For example, in some embodiments the agro-waste particles are date palm wood flour particles that comprise cellulose, hemicellulose, and lignin, wherein the amount of cellulose is in the range of 20 wt % to 80 wt %, preferably 30 wt % to 70 wt %, relative to the total weight of the date palm wood flour particles. In addition, the date palm wood flour particles may include no more than 30 wt %, preferably no more than 20 wt % of minerals that contain iron, magnesium, silicon, potassium, and calcium.

A weight ratio of the agro-waste particles to the polymer phase may vary in the range of 1:20 to 2:1, preferably 1:15 to 1:1, preferably 1:10 to 1:3. Accordingly, a volumetric concentration of the agro-waste particles in the polymer composite may be in the range of 5% to 65% by volume, preferably 7% to 50% by volume, preferably 10% to 30% by volume relative to the total volume of the polymer composite. In view of that, a volumetric concentration of the polymer phase in the polymer composite may be in the range of 35% to 95% by volume, preferably 50% to 93% by volume, preferably 70% to 90% by volume relative to the total volume of the polymer composite. The agro-waste particles may preferably be homogeneously dispersed in the polymer phase. As used herein, the term “homogeneously dispersed” refers to a condition where in any given fraction of the polymer composite, the volumetric concentration of the Agro-waste particles may be substantially the same.

According to the method, polymer pellets are surface treated, preferably are plasma treated. As used herein, the term “polymer pellets” may refer to polyolefin-containing materials, preferably polyolefin-containing waste plastics that are pelletized. Preferably, the polymer pellets contain polypropylene and may further contain at least one secondary polymer, as described previously. A composition of the “polymer pellets” may be substantially the same as the composition of the “polymer phase”; however, the term “polymer phase” may refer to a polymeric fraction of the polymer composite.

The polymer pellets may be obtained from packages of food containers, water bottles, milk bottles, detergent containers, industrial chemical containers, toys, caps, cable jacketing, automotive parts, medical supplies, etc. Pelletizing the polyolefin-containing waste plastics may be performed in a conventional pelletizer, as known to those skilled in the art. The polymer pellets may preferably contain at least 80 wt %, preferably at least 90 wt %, preferably at least 95 wt % of a polyolefin compound, e.g. polypropylene, relative to the total weight of the polymer pellets. Ata average diameter of the polymer pellets may vary in the range from about 0.1 to about 10 mm, preferably from about 0.2 to about 9 mm, from about 0.5 to about 8 mm. The polymer pellets may have various geometries including, without limitation, rectangular, cubical, cylindrical, spherical, pyramidal, conical, elliptical, etc. The polymer pellets may also have irregular geometries. The polymer pellets may preferably contain polypropylene and at least one secondary polymer selected from the group consisting of polyethylene, acrylic, polyamide, polystyrene, polyvinylchloride, acrylonitrile butadiene styrene, and polycarbonate, wherein a weight ratio of the secondary polymer to the polypropylene is 1:20 to 1:4, preferably 1:18 to 1:5, preferably 1:15 to 1:10.

To carry out the plasma treatment, the polymer pellets may preferably be placed in a plasma chamber, and a plasma gas with a sub-atmospheric pressure (i.e. a pressure of 0.9 atm to vacuum, or preferably 0.6 atm to 0.1 atm, or preferably 0.4 atm to 0.2 atm) may be introduced into the plasma chamber. The plasma gas may preferably be oxygen, ammonia, argon, and/or nitrogen, although an inert gas such as helium may also be used. As used herein, the term “plasma gas” may refer to a gaseous matter that contains ions and electrons. One way to form the plasma gas may be through electrically charging an inert gas. Plasma treating the polymer pellets may form oxygen functional groups, e.g., hydroxyl, carbonyl, carboxyl, aldehyde, etc. on a portion of a surface of the polymer pellets by causing ions and electrons present in the plasma gas to interact with the surface of the polymer pellets. The polymer pellets may be plasma treated for 1 to 5 minutes, preferably 2 to 4 minutes under the plasma gas. In some embodiments, a surface density of oxygen functional groups, e.g., hydroxyl, carbonyl, carboxyl, aldehyde, etc. on the surface of the polymer pellets after plasma treatment may be increased by at least 5% by mole, preferably 10% to 30% by mole, preferably 15% to 25% by mole, relative to an initial molar concentration of oxygen functional groups on the surface of untreated polymer pellets. The surface density of oxygen functional groups on the surface of the polymer pellets may preferably be measured by FTIR. Alternatively, the surface density of oxygen functional groups on the surface of the polymer pellets may be determined with methods known to those skilled in the art, e.g. titration, contact angle measurement, X-ray photoelectron spectroscopy (XPS), etc. After plasma treating, the polymer pellets may be washed with an organic solvent, e.g. acetone, an alcohol (e.g., ethanol), toluene, etc. and may be further washed with water.

In some embodiments, the polymer pellets may be corona treated before and/or after plasma treatment. Accordingly, the polymer pellets may be subjected to a plasma that may be generated in air at an atmospheric pressure (i.e. about 1 atm) by applying an AC voltage to two electrodes of a corona treating device. The plasma may contain a number of energetic ions and electrons that may form oxygen functional groups, e.g., hydroxyl, carbonyl, carboxyl, aldehyde, etc. on a portion of the surface of the polymer pellets.

Corona treating the polymer pellets may enhance a surface energy of the polymer pellets. The polymer pellets may have chemically inert and nonporous surfaces (i.e. macro-pores with average pore diameter above 1 μm, preferably above 5 μm) with relatively low surface tensions causing them to be non-receptive to bonding with the agro-waste particles. Accordingly, corona treating may enhance a surface roughness of the polymer pellets by oxidizing a portion of the surface of the polymer pellets, thus improving adhesion bonds between the polymer phase and the agro-waste particles in the polymer composite. In one embodiment, the surface roughness of the polymer pellets may be enhanced/increased by at least 5%, preferably 10% to 20%, preferably about 15%, relative to the surface roughness of untreated polymer pellets. The surface roughness of the polymer pellets may preferably be measured with atomic force microscopy (AFM). Alternative methods of measuring surface roughness may also be used, as known to those skilled in the art, e.g. SEM.

In some embodiments, the polymer pellets may be acid-treated with an acid solution preferably before plasma treating in order to remove impurities, e.g. residuals of foods, drug, detergents, etc. from the surfaces of the polymer pellets. Acid-treating the polymer pellets may considerably affect a surface morphology and/or a surface chemistry of the polymer pellets, for example, by creating oxygen functional groups, e.g., hydroxyl, carbonyl, carboxyl, aldehyde, etc. on the surface of the polymer pellets. After acid-treatment, a surface density of oxygen functional groups, e.g., hydroxyl, carbonyl, carboxyl, aldehyde, etc. on the surface of the polymer pellets may be increased by at least 5% by mole, preferably 5% to 15% by mole, preferably about 10% by mole, relative to an initial molar concentration of oxygen functional groups on the surface of untreated polymer pellets. A composition and/or a concentration of the acid solution may be selected based on a composition of the polymer pellets. For example, in one embodiment the polymer pellets contain 80 wt % to 90 wt %, preferably 82 wt % to 88 wt % of polypropylene, and 10 wt % to 20 wt %, preferably 12 wt % to 18 wt % of polyethylene, wherein the polymer pellets are acid-treated with a sulfuric acid solution of 0.5 to 2.0 M, preferably 1.0 to 1.5 M, for 10 to 20 minutes, preferably 12 to 15 minutes. Alternative acid solutions that may be utilized for acid-treating the polymer pellets include, but are not limited to an iodic acid solution, a permanganic acid solution, a nitric acid solution, and/or a chromic acid solution. Preferably, the concentration of the acid solutions may be less than 2.0 M, preferably less than 1.5 M.

Additionally the polymer pellets may be flame treated preferably to break a portion of molecular chains on the surface of the polymer pellets, thus creating polar functional groups, preferably oxygen functional groups, e.g., hydroxyl, carbonyl, carboxyl, aldehyde, etc., on the surface of the polymer pellets. Accordingly, the polymer pellets may be subjected to a blue flame, e.g. an oxygen-containing propane flame or an oxygen-containing acetylene flame for a few seconds, preferably no more than 20 seconds, preferably no more than 10 seconds. In some embodiments, a surface density of oxygen functional groups, e.g., hydroxyl, carbonyl, carboxyl, aldehyde, etc. on the surface of the polymer pellets after flame treatment may be increased by at least 5% by mole, preferably 8% to 15% by mole, preferably about 10% by mole, relative to an initial molar concentration of oxygen functional groups on the surface of untreated polymer pellets. Additionally, flame treating the polymer pellets may advantageously burn off dust particles, and impurities, e.g. residuals of foods, detergents, etc. that may be present on the surface of the polymer pellets.

Although plasma treatment may be sufficient to form oxygen functional groups, e.g., hydroxyl, carbonyl, carboxyl, aldehyde, etc., on the surface of the polymer pellets, the polymer pellets may be subjected to two or more of the aforementioned treatment steps. For example, in a preferred embodiment, the polymer pellets may first be acid-treated and then plasma treated. In one embodiment, the polymer pellets may sequentially be flame treated, acid-treated, and plasma treated. In another embodiment, the polymer pellets may sequentially be flame treated, acid-treated, corona treated, and plasma treated.

The agro-waste particles may preferably be treated with one or more of an alkaline solution, an acid solution, an oxidizer, and a silane solution before mixing with the polymer pellets. Treating the agro-waste particles with one or more of the alkaline solution, the acid solution, and the oxidizer may remove organic impurities, e.g. fatty acids, carbohydrates, various types of proteins etc, from the agro-waste particles. In addition, treating the agro-waste particles with the silane solution may increase a nano-scale surface roughness of the agro-waste particles, thus may improve micromechanical interlocking for bonding between the polymer phase and the agro-waste particles in the polymer composite. In one embodiment, the silane solution contains an alkylalkoxysilane and/or an amino alkylalkoxysilane. Exemplary alkylalkoxysilanes include, without limitation, hexyhriethoxysilane, heptyltriethoxysilane, octyltriethoxysilane, nonyltriethoxysilane, decyltriethoxysilane, undecyltriethoxysilane, dodecyltrie-thoxysilane, tridecyltrietboxysilane, tetradecyltriethoxysilane, pentadecyhriethoxysilane, hexadecyltriethoxysilane, heptadecyltriethoxysilane, octadecyltriethoxysilane, and nonadecyltriethoxysilane, eicosyltriethoxysilane. Exemplary amino alkylalkoxysilane include, without limitation, aminopropyl trimethoxysilane, aminopropyl triethoxysilane, and N-(n-butyl)-3-amino-propyltrimethoxysilane.

In some embodiments, after treating the agro-waste particles with the silane solution, the nano-scale surface roughness of the agro-waste particles may be enhanced/increased by at least 5% by mole, preferably 10% to 20% by mole, preferably about 15% by mole, relative to an initial nano-scale surface roughness of untreated agro-waste particles. Nano-scale roughness of the agro-waste particles may preferably be determined by atomic force microscopy (AFM). In a preferred embodiment, the agro-waste particles are treated with a sodium hydroxide solution for 1 to 5 hours, preferably 2 to 3 hours, at a temperature of 20 to 30° C., preferably 22 to 28° C., preferably about 25° C. Alternative alkaline solutions that may, be utilized here may include, without limitation, a potassium hydroxide solution, a calcium hydroxide solution, and a magnesium hydroxide solution. Exemplary acid solutions for treating the agro-waste particles may preferably include, without limitation, a chromic acid solution, a sulfuric acid solution, a hydrochloric acid solution, and a hydrofluoric acid solution. Also, examples of the oxidizer that may be used to treat the agro-waste particles may include, without limitation, sodium hypochlorite, hydrogen peroxide, sodium percarbonate, and sodium perborate.

In a preferred embodiment, the agro-waste particles may be washed with water, preferably deionized water, after being treated with one or more of the alkaline solution, the acid solution, the oxidizer, and the silane solution. The agro-waste particles may further be dried at a temperature of 20 to 100° C., preferably 80 to 95° C. for 10 to 40 hours, preferably 12 to 36 hours, preferably about 24 hours. In some embodiments, the ago-waste particles may be dried at a temperature of 20 to 30° C., preferably 22 to 28 preferably about 25° C. for 10 to 40 hours, preferably 12 to 36 hours, and then post-dried at a temperature of 80 to 100° C., preferably 90 to 95° C. for another 10 to 40 hours, preferably 12 to 36 hours.

The agro-waste particles may be flame treated preferably before treating with one or more of the alkaline solution, the acid solution, the oxidizer, and the silane solution. Accordingly, the agro-waste particles may be subjected to a blue flame, e.g. an oxygen-containing propane flame or an oxygen-containing acetylene flame for no more than 10 seconds, preferably no more than 5 seconds, preferably no more than 3 seconds. Flame treating the agro-waste particles with an oxygen-containing propane or acetylene flame may functionalize the surface of the agro-waste particles with oxygen functional groups, e.g., hydroxyl, carbonyl, carboxyl, aldehyde, etc. which may further improve a wettability and/or adhesion properties of the agro-waste particles. In some embodiments, a surface density of oxygen functional groups, e.g., hydroxyl, carbonyl, carboxyl, aldehyde, etc. on the surface of the agro-waste particles after flame treatment may be increased by at least 5% by mole, preferably 8% to 15% by mole, preferably about 10% by mole, relative to an initial molar concentration of oxygen functional groups on the surface of untreated, agro-waste particles. The surface density of oxygen functional groups on the surface of the ago-waste particles may preferably be measured by MR. Alternatively, the surface density of oxygen functional groups on the surface of the agro-waste particles may be determined with methods known to those skilled in the art, e.g. titration, contact angle measurement, X-ray photoelectron spectroscopy (XPS), etc.

After surface treating the polymer pellets (e.g.) preferably by plasma treatment) and optionally after surface treating the agro-waste particles, these materials are mixed together to form a homogenous mixture. The agro-waste particles and the polymer pellets may be mixed with conventional methods known to those skilled in the art, e.g. using a tumble blender, a ribbon blender, or a Henschel-type mixer. The agro-waste particles may be, mixed with the polymer pellets at a weight ratio of 1:20 to 2:1, preferably 1:15 to 1:1, preferably 1:10 to 1:3. The agro-waste particles may be mixed with the polymer pellets until a homogeneous solid mixture is obtained. In view of that, the agro-waste particles may be mixed with the polymer pellets for 1 to 12 hours, preferably 2 to 5 hours.

The homogenous mixture is then heated to form an extrusion precursor, in a molten form. Appropriate operating conditions of heating the homogenous mixture may be readily determined by those skilled in the art. For example, in one embodiment, the homogenous mixture is heated to a temperature of 200 to 300° C. preferably, 210 to 260 preferably 220 to 240° C. to form the extrusion precursor.

To control a viscosity of the extrusion precursor, a rheology modifying agent may be mixed with the extrusion precursor, preferably in an amount of from about 0.3 wt % to 2.0 wt % preferably from about 0.4 it % to 0.6 wt %, relative to the total weight of the extrusion precursor. The rheology modifying agent may be a polymeric compound as known to those skilled in the art, e.g. low molecular weight anionic polymer rheology modifying agents such a polymaleic acid or copolymers of polymaleic acid and acrylic acid.

In embodiments when the polymer pellets are plasma treated, the homogenous mixture advantageously does not include a compatibilizing agent, or any other agent that strengthens the bonding between the agro-waste particles and the polymer phase. However, in some preferred embodiments, a compatibilizing agent is mixed with the homogenous mixture. As used in this disclosure, the terms “compatibilizing agent”, “compatibilizer”, and “coupling agent” may be used interchangeably throughout this disclosure.

The compatibilizer may include reactive groups that can react with the polymer phase under heat and shear by either a free radical or an ionic, reaction mechanism. The compatibilizing agent may be at least one compound selected from the group consisting of maleic anhydride grafted polypropylene, maleic anhydride grafted polyethylene, maleic anhydride grafted polystyrene, ethylene-propylene-maleic anhydride copolymer, ethylene-methyl acrylate copolymer, ethylene-ethyl acrylate copolymers, ethylene-acrylic acid copolymer, maleic anhydride ionomers (e.g., surlyn), vinyl acetate, methyl methacrylate, phenol formaldehyde, sodium silicate, isocynate, and, di-phenylmethane. Preferably, a weight ratio of the compatibilizing agent to the polymer pellets in the homogenous mixture may be in the range of 1:200 to 1:5, preferably 1:150 to 1:8, preferably 1:100 to 1:10. The maleic anhydride grafted polypropylene may be a preferable compatibilizing agent for polypropylene due to a polarity and anhydride functionality of the maleic anhydride grafted polypropylene. In view of that, in some preferred embodiments, maleic anhydride grafted polypropylene is mixed with polypropylene pellets at a weight ratio of 1:200 to 1:5, preferably 1:150 to 1:8, preferably 1:100 to 1:10.

In some embodiments, a UV stabilizer may be mixed with the homogenous mixture to inhibit or absorb UV radiation that can degrade the polymer pellets. The UV stabilizer may be at least one compound selected from the group consisting of a benzotriazole, a benzophenone, a benzoate, a nickel organic complex, and a hindered amine light stabilizer. The UV stabilizer may be mixed with the polymer pellets at a weight ratio of 1:1000 to 1:100, preferably 1:900 to 1:200, preferably 1:800 to 1:250.

In some embodiments, a lubricant is mixed with the homogenous mixture to facilitate extrusion of the extrusion precursor. The lubricant may preferably contain a silicone elastomer. Alternative lubricants, as known to those skilled in the art, may also be utilized. Preferably, the lubricant is mixed with the polymer pellets at a weight ratio of 1:100 to 1:10, preferably 1:95 to 1:12, preferably 1:90 to 1:15.

In order to control a density of the polymer composite, a foaming agent may be mixed with the homogeneous mixture or the extrusion precursor, preferably in an amount of from about 0.1 wt % to 3.0 wt %, preferably from about 0.2 wt % to 2.0 wt %, relative to the total weight of the extrusion precursor.

Additional additives may further be mixed with the homogeneous mixture or the extrusion precursor to improve one or more physical/mechanical properties of the polymer composite based on an application of the polymer composite. Exemplary additives may include, without limitation, tougheners, impact modifiers, antistatic agents, coloring agents, and antifungal agents. For example, in some embodiments, one or more impact modifiers may be mixed with the homogeneous mixture or the extrusion precursor to improve an impact property of the polymer composite. The impact modifier may include one or more compound selected from the group consisting of ionomer resins (e.g. surlyn), rubbers such as ethylene-propylene diene monomer (EPDM) or modified EPDM, ethylene vinyl acetate copolymers, ethylene-acrylic acid copolymers, ethylene-methacrylic acid copolymers, ethylene-ethyl acrylate, methyl methacrylate grafted polybutylene, methyl methacrylate-styrene grafted rubbers, styrene butadiene rubber, styrene-butadiene-styrene (S-B-S) block copolymers, acrylic rubbers, ethylene-methyl acrylate copolymers, ethylene-ethylacrylate copolymers, and polycarbonates. Accordingly, the amounts of impact modifiers may vary in the range from about 1 wt % to 25 wt %, preferably 2 wt % to 20 wt %, preferably 5 wt % to 15 wt %, relative to the total weight of the polymer composite.

After any optional compatibilizing agents, UV stabilizers, lubricants, foaming agents and/or additional additives have been added to form the desired extrusion precursor, the extrusion precursor is extruded with an extruder to form the polymer composite. The extruder may be a conventional extruder known to those skilled in the art, e.g. a twin-screw extruder or a continuous mixer/single-screw extruder. A torque of the extruder may be set to a value below 70 N·m, preferably below 60 N·m, and a screw rotational speed may preferably be set to a value in the range of 100 to 300 rpm, preferably 150 to 250 rpm, preferably about 200 rpm. Accordingly, the extrusion precursor in a molten form (with a temperature in the range of 120 to 250° C., preferably 140 to 230° C.) is forced through an extrusion die to fabricate the polymer composite. The polymer composite that is manufactured may have a fibril-containing surface. The polymer composite that comes out of the extruder may further be passed through a water bath, wherein a temperature of the polymer composite is reduced to a temperature of 10 to 40° C., preferably 20 to 30° C.

The polymer composite may preferably be extruded into strands with a length-to-diameter ratio (L/D) of 200:1 to 10:1, preferably 150:1 to 20:1, preferably 50:1 to 25:1. The strands may be pelletized, for example, with a conventional pelletizer; and polymer composite pellets may further be processed (i.e. extruded, molded, casted, etc.) into a specific structural profile using appropriate equipment as known to those skilled in the art. The polymer composite may preferably be extruded into a specific shape and geometry with the single-screw extruder equipped with a specific die. The polymer composite may be extruded at an extrusion ratio in the range of 5:1 to 100:1, preferably 10:1 to 50:1. The term “extrusion ratio” may refer to a ratio of a cross-sectional area of the extrusion precursor before extruding to the cross-sectional area of the polymer composite, i.e. after extruding.

The polymer composite may be used in various applications including, but not limited to car manufacturing, aerospace, electronics, pharmaceutical, medical devices, sport goods, kitchen supplies, food packages, water bottles, chemical containers, toy manufacturing, caps, wire, cable jacketing, etc. Depending on final applications of the polymer composite, additional processing steps may be involved. For example, the polymer composite may first be polished and then be coated with coloring dyes to be used in car manufacturing and aerospace industries.

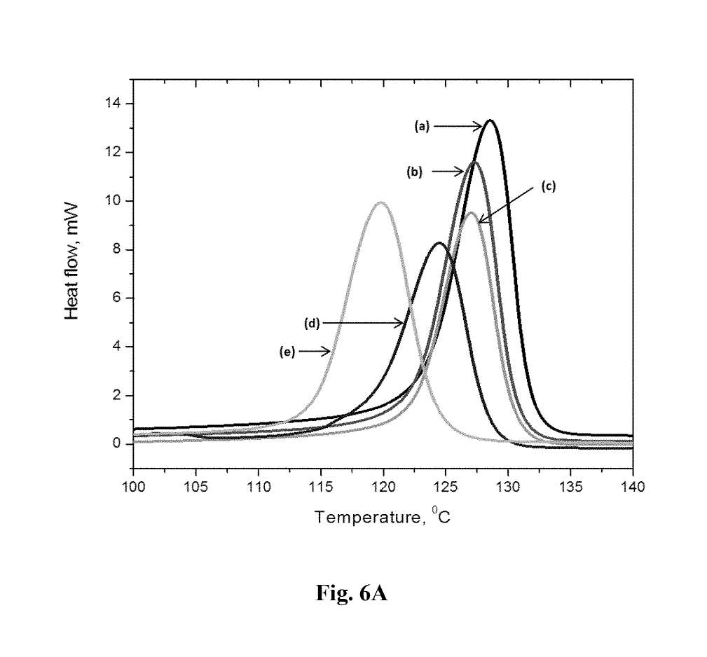

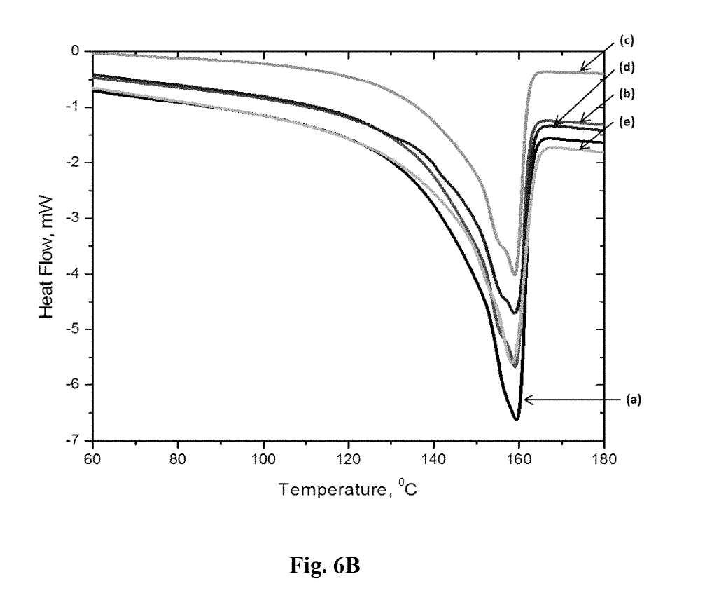

In some embodiments, the polymer phase of the polymer composite may be crystallizable, e.g. polypropylene and polyethylene with a crystallinity of 15% to 30%, preferably 18% to 28%, preferably about 20% to 25%, as shown in Table 1. The term “crystallinity” may refer to a ratio of a volume of a crystalline phase to the total volume of the polymer phase. In some embodiments, a crystallization temperature of the polymer phase in the polymer composite may be in the range of 110 to 140° C., preferably 115 to 135° C., preferably 120 to 130° C. The crystallization temperature of the polymer phase may be reduced by increasing the concentration of the agro-waste particles in the polymer composite, as shown in Table 1 and FIG. 6A.

In some embodiments, a melting temperature of the polymer phase in the polymer composite may be in the range of 150 to 165° C., preferably 155 to 160° C. The crystallization temperature of the polymer phase may not be substantially altered by increasing or decreasing the concentration of the agro-waste particles in the polymer composite, as shown in Table 1 and FIG. 6B.

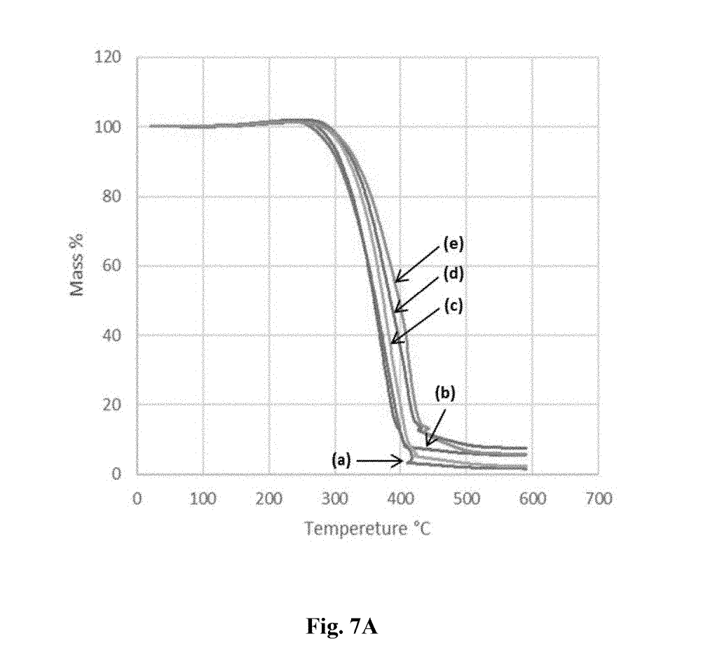

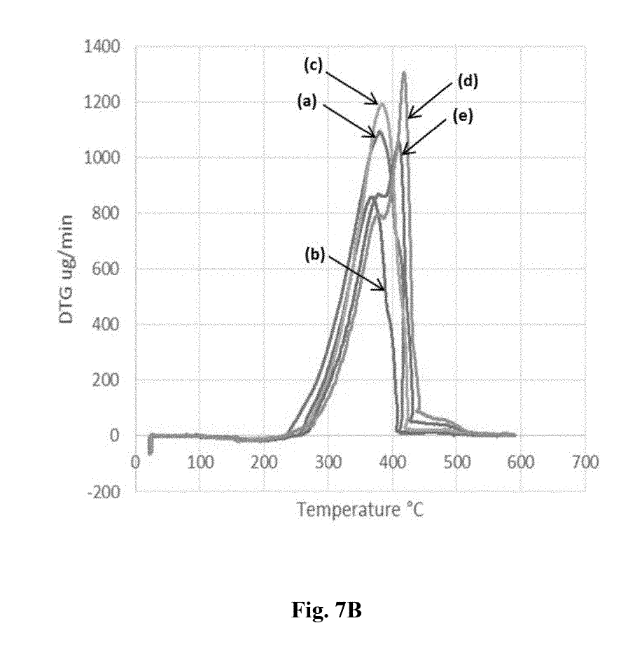

In some embodiments, a decomposition temperature of the polymer phase in the polymer composite may be in the range of 250 to 500° C., preferably 300 to 400° C. The decomposition temperature of the polymer phase may not be substantially altered by increasing or decreasing the concentration of the agro-waste particles in the polymer composite, as shown in FIG. 7A and FIG. 7B.

In one embodiment, the polymer composite includes 0 to 30 wt %, preferably 1 wt % to 28 wt % of the Agro-waste particles relative to the total weight of the polymer composite, wherein t equilibrium water mass uptake of the polymer composite varies in the range from about 0.01 wt % to about 5 wt %, preferably from about 0.05 wt % to about 4.0 wt %, relative to the total weight of the polymer composite. The equilibrium water mass uptake of the polymer composite may be increased by increasing the concentration of the agro-waste particles in the polymer composite, as shown in Table 2.

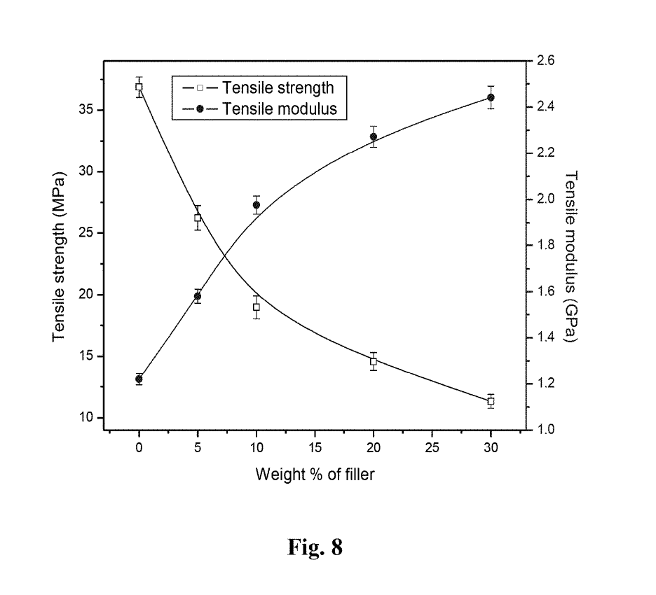

Mechanical properties of the polymer composite may vary depending on the composition of the polymer composite. For example, in one embodiment, the polymer composite includes 0 to 30 wt %, preferably 1 wt % to 28 wt % of the agro-waste particles relative to the total weight of the polymer composite, wherein a tensile strength of the polymer composite is in the range of 10 to 50 MPa, preferably 12 to 40 MPa. The tensile strength of the polymer composite may be reduced by increasing the concentration of the agro-waste particles, as shown in FIG. 8. The tensile strength of the polymer composite may be determined by the method as described in the ISO 527.

In another embodiment, the polymer composite includes 0 to 30 wt %, preferably 1 wt % to 28 wt % of the agro-waste particles relative to the total weight of the polymer composite, wherein a tensile modulus of the polymer composite is in the range of 1.0 to 3.0 GPa, preferably 1.2 to 2.4 GPa. The tensile modulus of the polymer composite may be increased by increasing the concentration of the agro-waste particles, as shown in FIG. 8. The tensile modulus of the polymer composite may be determined by the method as described in the ISO 527.

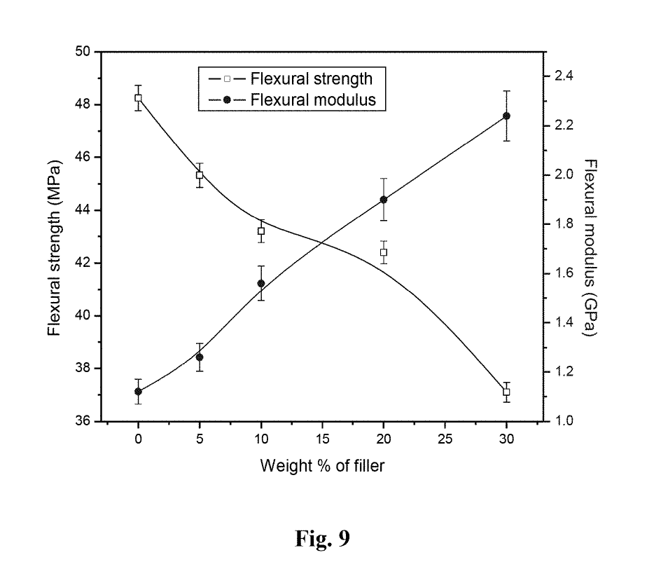

In another embodiment, the polymer composite includes 0 to 30 wt %, preferably 1 wt % to 28 wt % of the agro-waste particles relative to the total weight of the polymer composite, wherein a flexural strength of the polymer composite is in the range of 30 to 50 MPa, preferably 35 to 48 MPa. The flexural strength of the polymer composite may be reduced by increasing the concentration of the agro-waste particles, as shown in FIG. 9. The flexural strength of the polymer composite may be determined by the method as described in the ISO 178.

Yet in another embodiment, the polymer composite includes 0 to 30 wt %, preferably 1 wt % to 28 wt % of the agro-waste particles relative to the total weight of the polymer composite, wherein a flexural modulus of the polymer composite is in the range of 1.0 to 2.5 GPa, preferably 1.1 to 2.3 GPa. The flexural modulus of the polymer composite may be increased by increasing the concentration of the agro-waste particles, as shown in FIG. 9. The flexural modulus of the polymer composite may be determined by the method as described in the ISO 178.

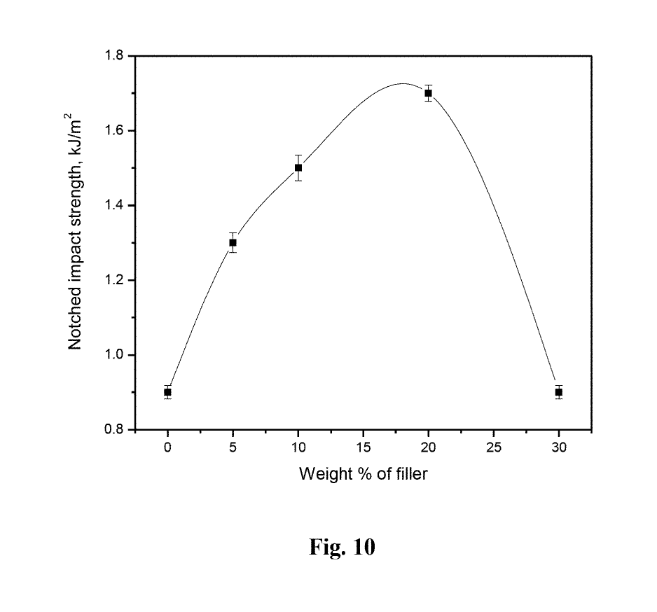

In another embodiment the polymer composite includes 0 to 30 wt %, preferably 5 wt % to 20 wt % of the agro-waste particles, relative to the total weight of the polymer composite, wherein an impact strength of the polymer composite is in the range of 1.2 to 2.0 kJ/m², preferably 1.3 to 1.8 kJ/m². The impact strength of the polymer composite may be increased by increasing the concentration of the ago-waste particles up to about 10 wt % to 25 wt %, preferably about 15 wt % to 20 wt % of the agro-waste particles, and then decreased by increasing the concentration of the agro-waste particles. In view of that, the impact strength of the polymer composite may be maximized at about 10 wt % to 25 wt %, preferably about 15 wt % to 20 wt % of the agro-waste particles, as shown in FIG. 10. The impact strength of the polymer composite may be determined by charpy method as described in the ISO 179.

The method of the present disclosure may provide an inexpensive and renewable source for polymer fillers which may lead to reduce an overall cost of manufacturing the polymer composite and discharging/incinerating agro-waste materials and polyolefin-containing waste plastics into the environment. A cost of manufacturing the polymer composite may be at least two times, preferably at least three times, preferably at least five times lower than the cost of manufacturing a polymer composite that includes fillers other than the agro-waste particles. Therefore, it can be readily understood that the method may contribute to ecology, wood preservation, public health, environmental protection, solid waste management, and pollution control.

The examples below are intended to further illustrate protocols for the method of manufacturing the polymer composite, and are not intended to limit the scope of the claims.

### Example 1—Materials and Processing

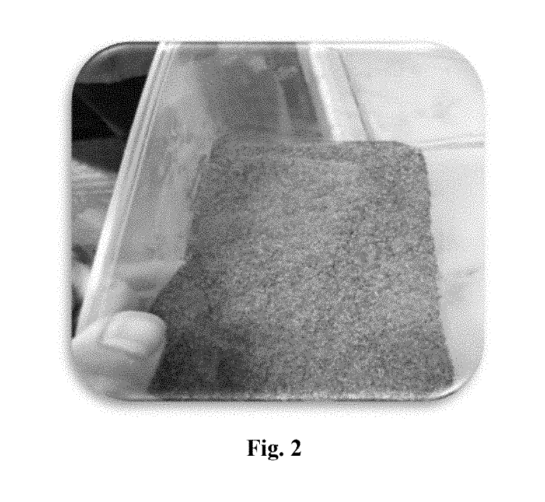

The wood flour reinforcement used in the composite was from date palm species obtained from Yanbu, Saudi Arabia. The grinded wood flour was treated with 5% concentration NaOH solution for 2 hours at room temperature. The ratio of NaOH solution to wood flour was 20:1 in terms of weight percent. The wood flour was washed thoroughly with distilled water to remove the excess of NaOH in the wood flour. The wood flour was dried under the ambient conditions for 24 h and then dried in an oven at 0-100° C. for 12-24 hours and thereafter stored in sealed plastic covers. An average particle size of the date palm wood flour particle, shown in FIG. 2, ranges from about 400 to about 850 microns.

The polypropylenes used were also collected from local stores and households. They were mainly used as food containers for yoghurt, leban, etc. The collected containers w re cleaned, washed, and dried. Then, they were cut into small pieces of regular sizes. Maleic anhydride grafted PP (5% by weight of PP) was used as a compatibilizer.

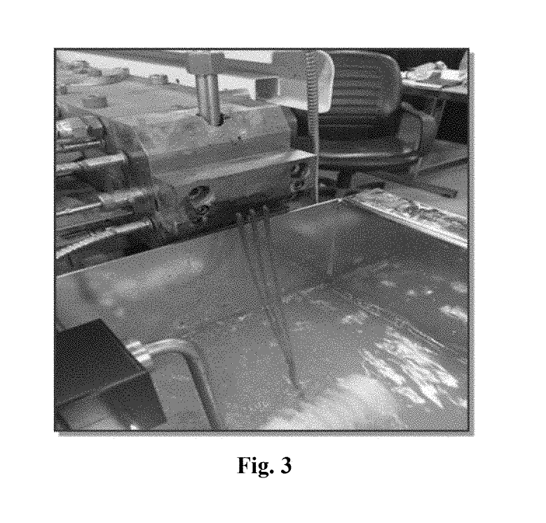

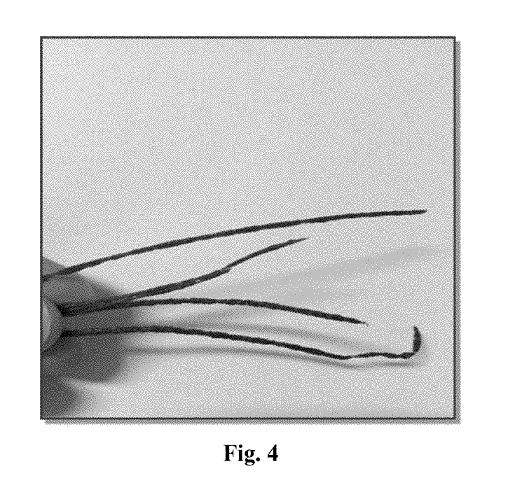

The processing steps, as shown in FIG. 1C, are detailed bellow: (a) wood flour and polypropylene waste materials were collected and cleaned from contaminants, (b) the polypropylene waste materials were pelletized into 2-10 mm, and the wood flour was sieved with mesh screens with a mesh size number ranging from 20 to 40, (c) the sieved wood flour and the pelletized polypropylene waste materials were mixed in a tumbler mixer, and (d) the resulting mixture was fed into a PTW/24/40-MC OS Twin Screw Extruder through hopper. The feeds were be mixed using co-rotating twin screw extruder, small amount of materials were added in order to maintain torque less than 60 N·m, and the materials were melted at a temperature around 230° C. The screws push the mixtures towards the die head. The extrudate was then passed through a cooling water bath, as shown in FIG. 3, and the collected strands, as shown in FIG. 4, were pelletized and used for characterization.

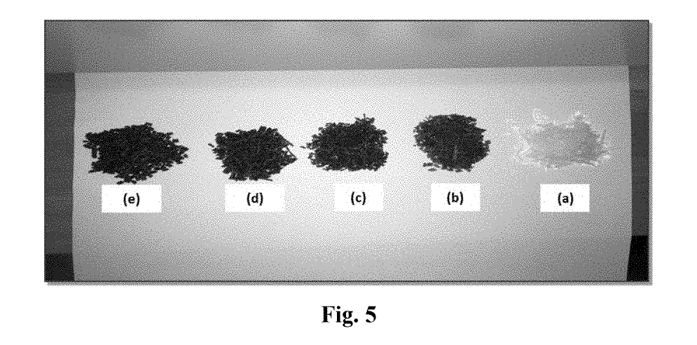

As shown in FIG. 5, five samples with wood flour content of 0, 5, 10, 20 and 30 wt (%) were prepared using modular co-rotating 24 mm twin screw extruder with an L/D ratio of 25:1 (Haake Rheodrive 16 OS16M° C.). The temperature profile was (140-160-180-200-200-210-220-220-230-230° C.) and the screw speed was 200 rpm. The obtained strands were pelletized using a pelletizer and injection molded using a minijet II (Thermo) at 230° C. The molds were kept at 40° C. and the air pressure was 7 bars. The samples were designated as 0, 5, 10, and so on where the number stands for the amount of filler incorporated into the matrix.

### Example 2—DSC

The melting and crystallization behavior of the composites were studied by Shimadzu DSC 60 machine under nitrogen atmosphere. Accordingly, 5 mg of the samples were kept in aluminum pans and the heating rate was set to 10° C. per minute. The temperature profile for the measurements was, 1) first heating to 230° C. and 2 minutes hold, 2) cooling to room temperature (27° C.) and 2 minutes hold and 3) second heating to 230° C. The first cooling and second heating data were utilized to plot the curves and analysis. Crystallization temperature (T_{c}) and enthalpy (ΔH_{f}) were measured from the first cooling run, while the peak melting temperature (Tₘ) and melting enthalpy (ΔHₘ) were determined from second heating cycle. The crystallinity (X_{c}) was determined using the following equation:

$${X}_{c} = \frac{Δ {H}_{f}}{Δ {H}_{f 100} \times w} \times 100 \%$$

where, ΔH_{f} is the heat of fusion of the neat polymer or composites and ΔH_{f100} is the theoretical heat of fusion for a 100% crystalline polymer (ΔH_{f100}=205 J/g for PP) and w is the mass fraction of thermoplastic in the composite samples.

DSC data can detect any change that alters the heat flow in and out of a sample. This includes more than just glass transitions and melting. You can see solid state transitions such as eutectic points, melting and conversions of different crystalline phases like polymorphic forms, dissolution and precipitation from solutions, crystallization and re-crystallizations, curing exotherms, degradation, loss of solvents, and chemical reactions. FIGS. 6A and 6B show the crystallization and melting peaks of the PP/WF composites, and Table 1 gives the numerical values from the analysis of the curves. With respect to the filler loading the crystallization temperature shows a decrease from the 0 wt % loading composites. The crystallization starts at a lower temperature and it affects the crystallinity of the composites too. The melting peaks show not much significant changes with respect to the filler loading.

TABLE 1
DSC Results

| | Crystallization | Enthalpy of | Melting | |
|---|---|---|---|---|
| Wood | Temperature | Crystallization | Temperature | Crystallinity |
| Flour % | (C.°) | (J/g) | (C.°) | % |
| 0 | 128.54 | 84.54 | 159.33 | 19.32 |
| 5% | 127.34 | 67.39 | 159.11 | 19.97 |
| 10% | 127.12 | 56.94 | 158.96 | 20.03 |
| 20% | 124.57 | 62.89 | 158.81 | 21.56 |
| 30% | 119.83 | 72.88 | 158.35 | 24.33 |

### Example 3—TGA

Thermogravimetric analysis of the composites was done using Hitachi STA7200 simultaneous thermal analyzer system. The heating rate was set to 10° C./min and the samples were purged with nitrogen to provide inert atmosphere. The samples were heated from room temperature to 600° C. The TGA curves, DTG curves, maximum degradation temperature and char residue were calculated.

The thermal stability of the five PP/WF composites was determined by thermogravimetry. The mass loss increases with temperature, for a heating rate of 10° C./min, are shown in FIG. 7A. The curves show a mass loss which is starting between 250 and 300° C., which can be attributed to the evaporation of water present in the sample. The mass loss increases gradually up to a value between 400 and 430° C. The five samples showed a mass loss of around 90-95% on reaching 420° C.

The degradation of the PP/WF composites presents one peak as seen in the DTG curves (FIG. 7B). In the region between 350 and 430° C. two distinct events occur for 0% & 20%. The first event, observed at 350-400° C., can be associated with the decomposition of hemicellulose and the slow degradation of lignin. The second event at between 400 and 430° C. can be attributed to the degradation of cellulose. For others, composites the degradation of cellulose occur between 340 and 420° C.

### Example 4—Water Sorption

Water absorption and thickness swelling tests were conducted in accordance with ASTM D57098, in which the specimens were immersed in water for 2 h and 24 h, respectively, at a temperature of 23±1° C. The weight gain and thickness increase were measured 20 minutes after the samples were removed from the water. After 24 h water immersion tests, all of the specimens were oven dried after the test at 105° C. to obtain the oven dry mass for the calculation of the final moisture content (MC) using the following equation:

$$Waterabsorption = \frac{( {m}_{t} - {m}_{0} )}{{m}_{0}} \times 100 \%$$

where, mₒ and mₜ are the oven dry mass (kg) and the mass (kg) after time t, in the water immersion test, respectively. Equilibrium moisture content (EMC) of the samples is the moisture content when the daily weight change of the sample was less than 0.01% and thus the equilibrium state was assumed to be reached. Density of the composite was determined based on the oven dry weight and the volume before the water immersion test. In the water immersion tests, thickness of each composite sample was also measured for determination of the thickness swelling (TS) by using the following equation:

$$TS \% = \frac{( {h}_{t} - {h}_{0} )}{{h}_{0}} \times 100 \%$$

where hₒ and hₜ are the panel thickness (mm) before and after the water immersion, respectively.

Table 2 shows the results of the water absorption tests carried out on the recycled PP wood flour composites for different times. It is observed in that the reduced weight after oven, characterizing the presence of moisture in the composites before the drying process. The composites had an increase in mass change after 1 week of immersion. However, the weight of the samples didn't change much even after 4 weeks of immersion. The composite 30% WF obtained a variation in the total mass of 4% after one week and it remained almost constant even after four weeks. It can be concluded that water absorption became saturated within one week. This is applicable for any outdoor applications for the composites.

TABLE 2
Water absorption test values of the composites

| | Initial | Change of weight (%) | | | |
|---|---|---|---|---|---|
| Sample | weight (g) | After oven | 1 hr | 24 hours | 1 week |
| 0 | 4.02 | (−) 0.08 | (−) 0.03 | 0.03 | 0.04 |
| 5 | 4.03 | (−) 0.11 | 0.05 | 0.23 | 0.9 |
| 10 | 4.12 | (−) 0.18 | 0.08 | 0.29 | 1.72 |
| 20 | 4.097 | (−) 0.29 | 0.13 | 0.38 | 2.9 |
| 30 | 4.05 | (−) 0.35 | 0.16 | 0.74 | 4.0 |

### Example 5—Mechanical Properties

The mechanical properties of PP and PP/wood flour were studied in tensile, stress, and impact tests. Tensile and Flexural testing was performed using an Instron (3365) universal testing machine of 10 kN load cell, based on ISO standards 527 and 178, respectively. Notched and unnotched samples were used in the izod mode with a 5J hammer.

FIG. 8 shows the results of tensile strength test and tensile modulus test. From the graph we conclude that 0% of filler (PP) is the strongest, it has a tensile strength of 36.87 MPa and 1.22 GPa tensile modulus. The 5% of filler is the strongest among the other filler percentages (5%, 10%, 20%, and 30%) with a maximum tensile strength of 26.24 MPa and 1.58 GPa tensile modulus.

FIG. 9 shows the results of flexural strength and flexural modulus tests. From the graph we conclude that the 0% of filler (PP) is the strongest, it has a maximum flexural strength of 48.25 MPa and a flexural modulus of 1.12 GPa. The 5% of filler is the strongest among the other filler percentages (5%, 10%, 20%, and 30%) with a maximum flexural strength of 45.32 MPa and a flexural modulus of 1.26 GPa before it is fractured.

FIG. 10 shows the results of notched impact strength test. From the graph e conclude that the 20% of filler is the strongest among the other filler percentage 5%, 10%, 20%, and 30%) because it has the maximum impact resistance.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter s dedicated to the public.

1. A method of manufacturing a polymer composite comprising a polymer phase and agro-waste particles dispersed in the polymer phase, the method comprising:
plasma treating polymer pellets, which comprise at least 80% by weight of a polyolefin relative to the total weight of the polymer pellets;
mixing agro-waste particles with the polymer pellets to form a homogenous mixture;
heating the homogenous mixture to form an extrusion precursor; and
extruding the extrusion precursor thereby forming the polymer composite.

2. The method of claim 1, wherein the agro-waste particles are mixed with the polymer pellets at a weight ratio of 1:20 to 2:1.

3. The method of claim 1, further comprising:
treating the agro-waste particles with an alkaline solution, an acid solution, an oxidizer, and/or a silane solution before the mixing.

4. The method of claim 3, wherein the Agro-waste particles are treated with the alkaline solution, the acid solution, the oxidizer, and the silane solution,
wherein the alkaline solution is a sodium hydroxide solution,
wherein the acid solution is a chromic acid solution and/or a sulfuric acid solution, and
wherein the oxidizer is at least one selected from the group consisting of sodium hypochlorite, hydrogen peroxide, sodium percarbonate, and sodium perforate.

5. The method of claim 3, further comprising:
flame treating the agro-waste particles before the treating.

6. The method of claim 1; further comprising:
corona treating the polymer pellets before the mixing.

7. The method of claim 1, further comprising:
acid treating the polymer pellets before the plasma treating.

8. The method of claim 1, further comprising:
washing the agro-waste particles and drying at a temperature of 20 to 100° C. before the mixing; and
cooling the polymer composite in a water bath after the extruding.

9. The method of claim 1, wherein the homogenous mixture is heated to a temperature of 200 to 300° C. to form the extrusion precursor.

10. The method of claim 1,
wherein the polyolefin is polypropylene and the polymer pellets further comprise at least one secondary polymer selected from the group consisting of polyethylene, acrylic, polyamide, polystyrene, polyvinylchloride, acrylonitrile butadiene styrene, and polycarbonate, and
wherein a weight ratio of the secondary polymer to the polypropylene is 1:20 to 1:4.

11. The method of claim 1, wherein the agro-waste particles comprise date palm wood flour particles.

12. The method of claim 1, wherein an average particle diameter of the agro-waste particles is in the range of 100 to 1,000 μm.

13. The method of claim 1, wherein the homogenous mixture does not include a compatibilizing agent.

14. The method of claim 1, further comprising:
mixing a compatibilizing agent with the agro-waste particles and the polymer pellets to form the homogenous mixture,
wherein the compatibilizing agent is at least one compound selected from the group consisting of maleic anhydride grafted polyethylene, maleic anhydride grafted polystyrene, vinyl acetate, methyl methacrylate, phenol formaldehyde, and sodium silicate, and
wherein the compatibilizing agent is mixed with the polymer pellets at a weight ratio of 1:200 to 1:5.

15. The method of claim 1, further comprising:
mixing a UV stabilizer with the agro-waste particles and the polymer pellets to form the homogenous mixture,
wherein the UV stabilizer is at least one compound selected from the group consisting of a benzotriazole, a benzophenone, a benzoate, a nickel organic complex, and a hindered amine light stabilizer, and
wherein the UV stabilizer is mixed with the polymer pellets at a weight ratio of 1:1000 to 1:100.

16. The method of claim 1, further comprising:
mixing a lubricant with the agro-waste particles and the polymer pellets to form the homogenous mixture,
wherein the lubricant comprises a silicone elastomer, and
wherein the lubricant is mixed with the polymer pellets at a weight ratio of 1:100 to 1:10.

17. The method of claim 1, wherein the polymer pellets are obtained from pelletizing polyolefin-containing waste plastics.

18. The method of claim 1, wherein an average diameter of the polymer pellets is 0.1 to 10 mm.

19. The method of claim 14,
wherein the polymer pellets are polypropylene pellets,
wherein the compatibilizing agent is maleic anhydride grafted polypropylene, and
wherein, the compatibilizing agent is mixed with the polypropylene pellets at a weight ratio of 1:100 to 1:10.

20. The method of claim 1, wherein the polymer composite has at least one of the following properties,
a tensile strength of 10 to 50 MPa,
a tensile modulus of 1.0 to 3.0 GPa,
a flexural strength of 30 to 50 MPa,
a flexural modulus of 1.0 to 2.5 GPa, and
an impact strength of 1.2 to 2.0 kJ/m².
